(19) United States
(12) Patent Application Publication
(10) Pub. No.: US 2015/0101302 A1
(43) Pub. Date: Apr. 16, 2015

(54) String Trimmer Rack Apparatus with Foot Control for Zero-turn Lawn Mower

(71) Applicant: Micah Joel Cooper, Madisonville, TN (US)

(72) Inventor: Micah Joel Cooper, Madisonville, TN (US)

(21) Appl. No.: 14/052,771

(22) Filed: Oct. 13, 2013

(51) Int. Cl. A01D 43/16

(52) U.S. Cl. CPC A01D 43/16
USPC 56/13.7

(57) ABSTRACT

Current embodiment: A string trimmer rack apparatus of the type having a rigid shaft (13) of sufficient size for holding a commercial string trimmer with a trimmer shaft cradle (2) and trimmer hand grip cradle (15). The main shaft (13) is connected by a swivel point (9), to a vertical shaft (26) which joins to tractor mount for attaching to a commercial zero-turn mower's frame. A foot control (12) allows operation of flotation, or pitch of string trimmer's string head and bumping of string trimmer's string head against a hard surface, or the ground to feed more trimmer line. Other embodiments are described and shown.

### CROSS-REFERENCE TO RELATED APPLICATIONS

This application claims the benefit of provisional patent application Ser. No. 61/714,023 filed 2012 Oct. 15 by the present inventor.

### BACKGROUND

### Prior Art

The following is a tabulation of some prior art that presently appears relevant.

U.S. Patents

| Patent Number | Kind Code | Issue Date | Patentee |
|---|---|---|---|
| 5,598,689 | | 1997 Feb. 04 | Bork |
| 7,975,459 | B1 | 2011 Jul. 12 | Murawski |
| 5,167,108 | | 1992 Dec. 01 | Bird |
| 6,986,238 | B1 | 2006 Jan. 17 | Bloodworth |

What is the one thing we all hate to do after mowing the lawn? Of course, using the string trimmer and all the fatigue that comes with it.

As bad as that is, imagine all the professionals who mow and trim everyday as a profession. What they would give for a system that allows them to mow and trim at the same time or trim as they ride their commercial zero-turn mowers.

Therefore, several attempts have been made to design a system, but because of their size, weight, bulkiness, and lack of manual control they have for the most part been unsuccessful.

For example; U.S. Pat. No. 5,598,689 to Bork (1997), U.S. Pat. No. 7,975,459 to Murawski (2011), U.S. Pat. No. 5,167,108 to Bird (1992). Most of these designs are relatively expensive to manufacture. They protrude from the side of the lawn mower making the lawn mower either unstable or difficult to get into tight areas. The extra weight and bulkiness does not work well in the commercial user's environment, where time is of the essence.

Also, as illustrated in U.S. Pat. No. 6,986,238 to Bloodworth (2006), the design requires the operator to use one hand for trimming and one hand for driving the mower but modern zero-turn commercial lawn mowers for the most part require the operator to use both hands for driving the mower. Driving the mower with a device such as;

U.S. Pat. No. 6,986,238 to Bloodworth (2006), would be unsafe for commercial zero-turn lawn mowers for the following reasons:

(a) These previous devices are too bulky, heavy, slow, and unstable to be used in a commercial mowing operation.

(b) They require the operator to sacrifice the maneuverability of the lawn mower.

(c) The lack of manual operator control makes them very hard to use. Most of all mentioned devices derive their flotation from wheels that roll along the ground, so if a sudden change occurs in the ground contour outside of the floatation wheels coverage, the string trimmer's line can strike the turf causing damage.

(d) When trimmer line, is worn short most of the aforementioned devices require the operator to stop and replace the trimmer line using valuable time.

(e) The removal of most of these aforementioned devices is time consuming or difficult, so most commercial users will not use them.

(f) The lack of being able to easily and quickly remove the string trimmer and trim by hand on aforementioned devices is also discouraging.

(g) Commercial zero-turn lawn mowers, for the most part, require both hand for operation, so hand floatation is not desirable for safety.

So as one skilled in the art can see, these aforementioned devices will not work well on zero-turn commercial lawn mowers.

### SUMMARY

In accordance with the current embodiment, a trimmer rack system that allows a hand held string trimmer and a zero-turn commercial lawn mower to be used simultaneously or independently, with a foot control, to control flotation of the string trimmer's string head, allowing bumping action of string head against a hard surface or ground to feed more trimmer line, all with the use of the foot control.

### Advantages

Advantages are that it allows the operator's hands to be used for the driving of the mower, and the operator's foot for the flotation of string trimmer's string head.

Engine throttle of string trimmer, angle, and height of cut can all be controlled by operator with attached controls on trimmer rack.

### DRAWINGS

### Figures

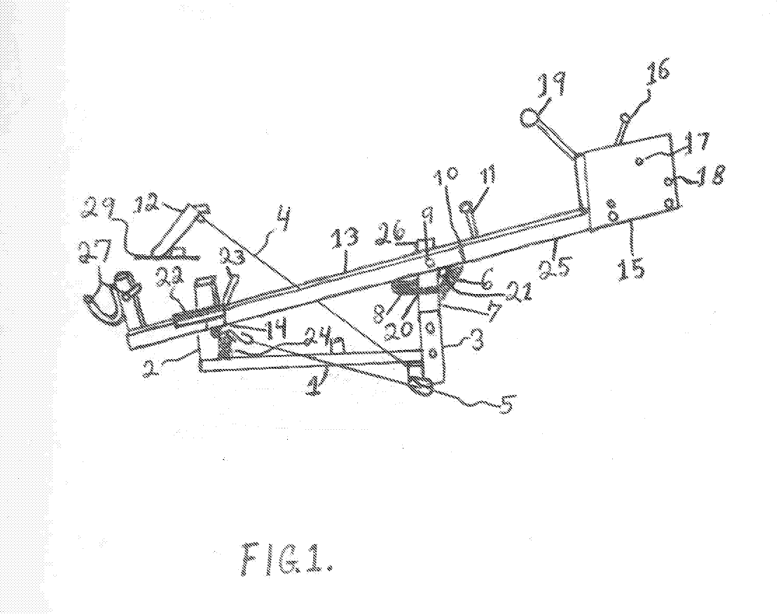

FIG. 1 shows current embodiment of the string trimmer rack from left side with cradle for holding trimmer shaft shown to the extreme left end or front. The hand grip cradle is shown on far right end or butt. The foot pedal and cable are also shown (where the tractor mount L arm connects to zero-turn mower's main frame is not shown)

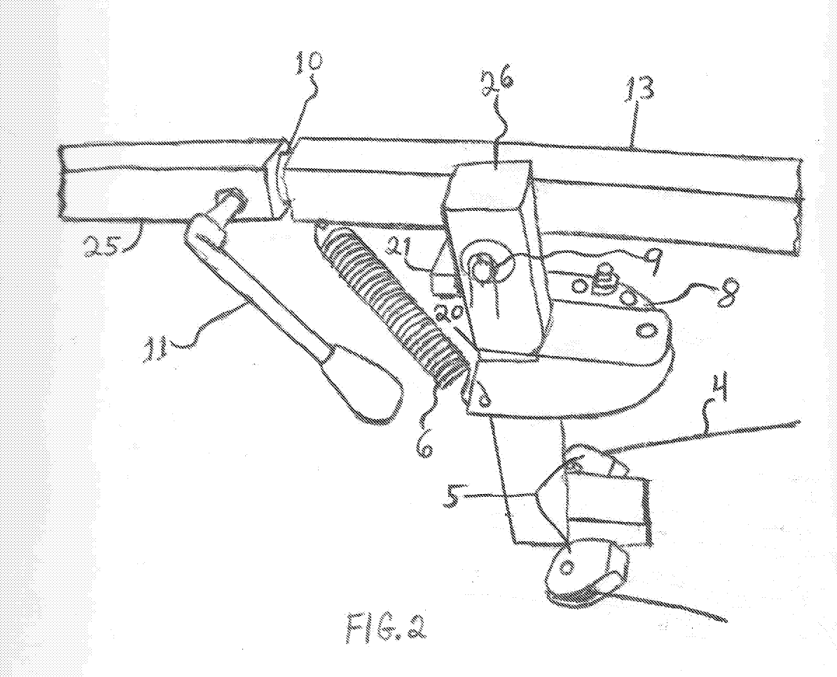

FIG. 2 shows the opposite or right side of the string trimmer rack with its mechanical functions. The pulley's and cable are also shown.

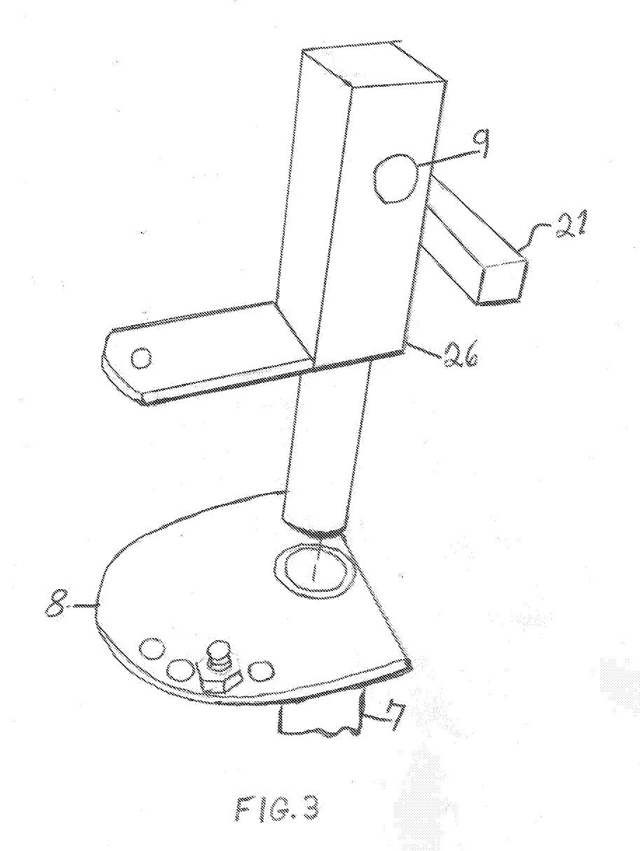

FIG. 3 shows the adjustable vertical support pole and pitch axis to yaw axis support shaft slightly separated.

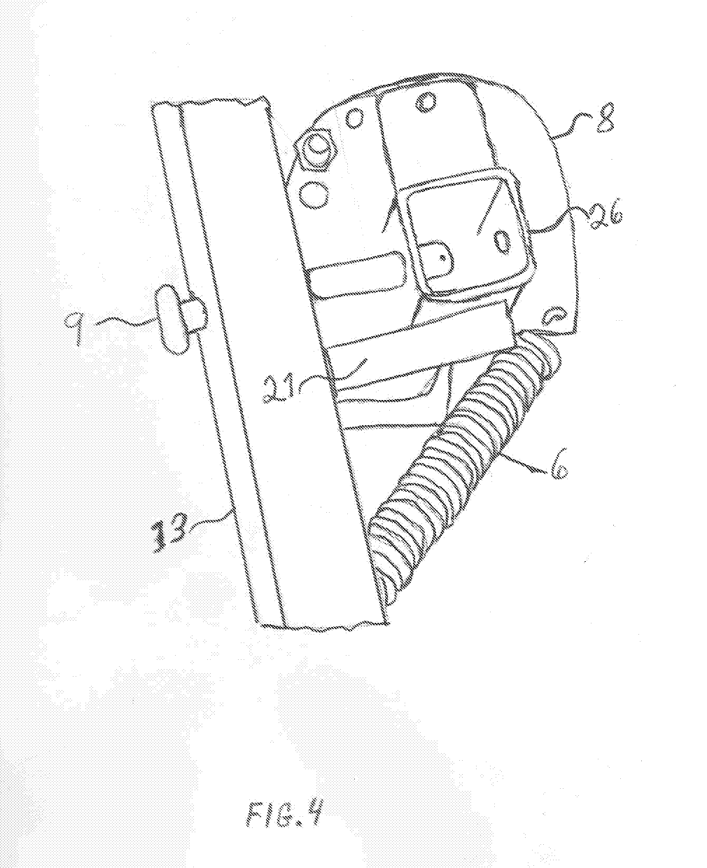

FIG. 4 shows pitch axis to yaw axis support shaft and main support shaft slightly separated.

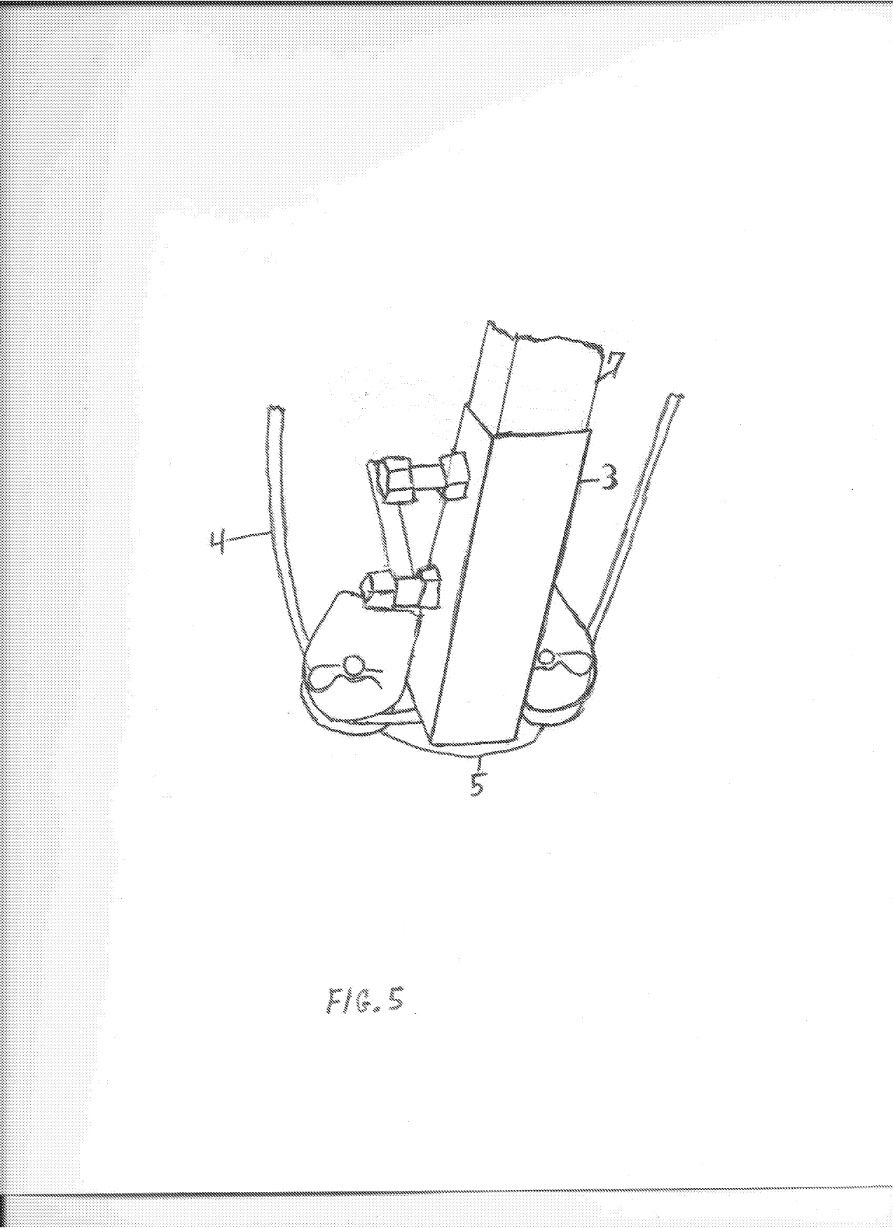

FIG. 5 shows back view of adjustable L arm with cable pulleys clearly shown

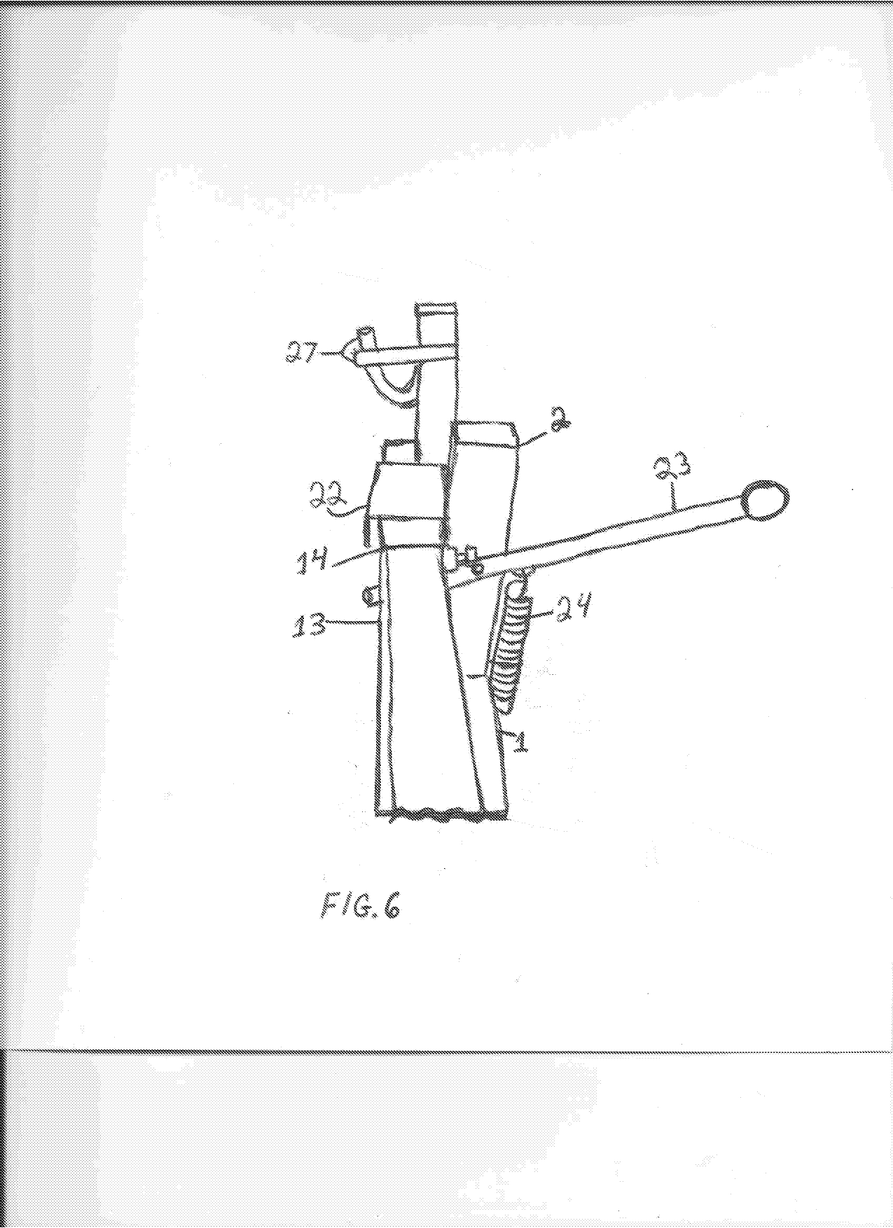

FIG. 6 shows main support shaft locked in main support shaft transport cradle support shaft. Locking and release handle is clearly shown.

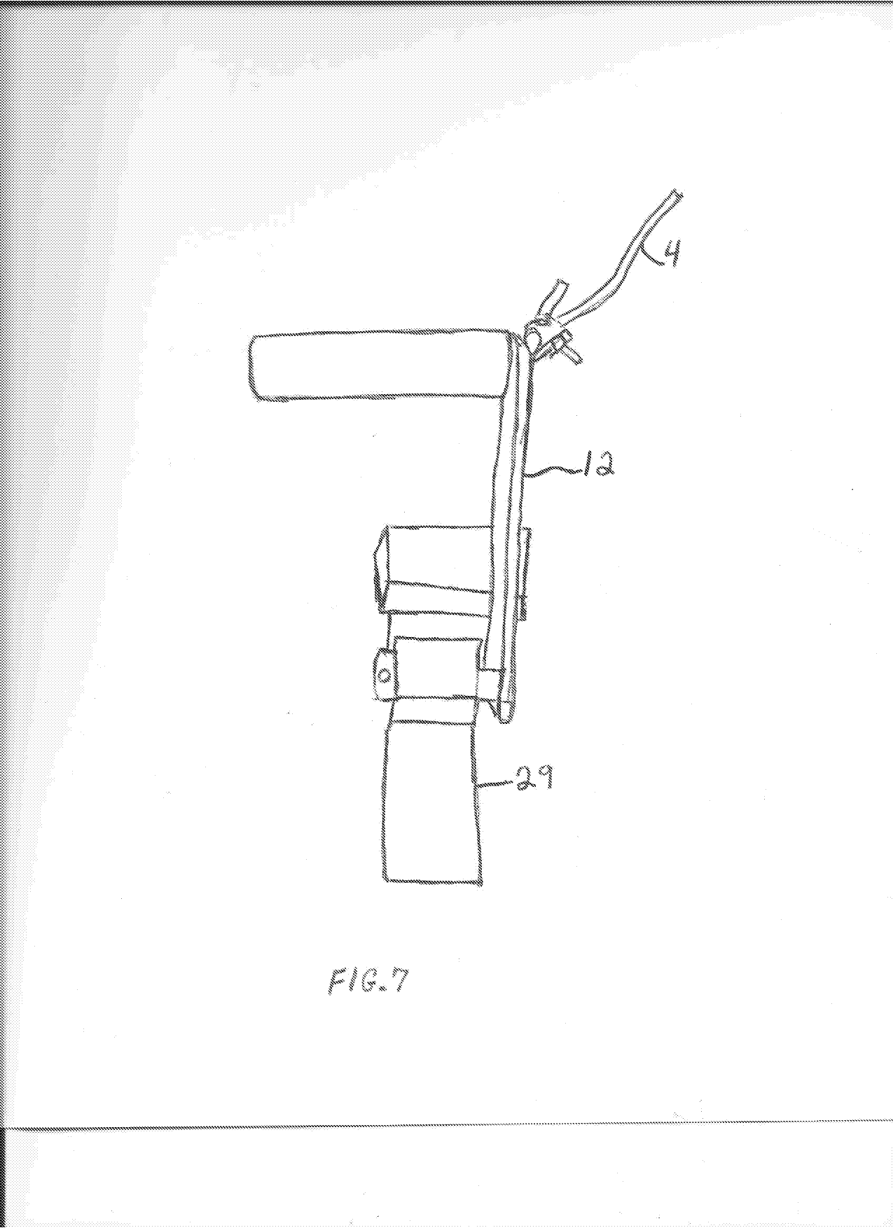

FIG. 7 shows the pitch (flotation of string trimmer's string head) and string feed foot pedal with mount plate and cable shown from front view.

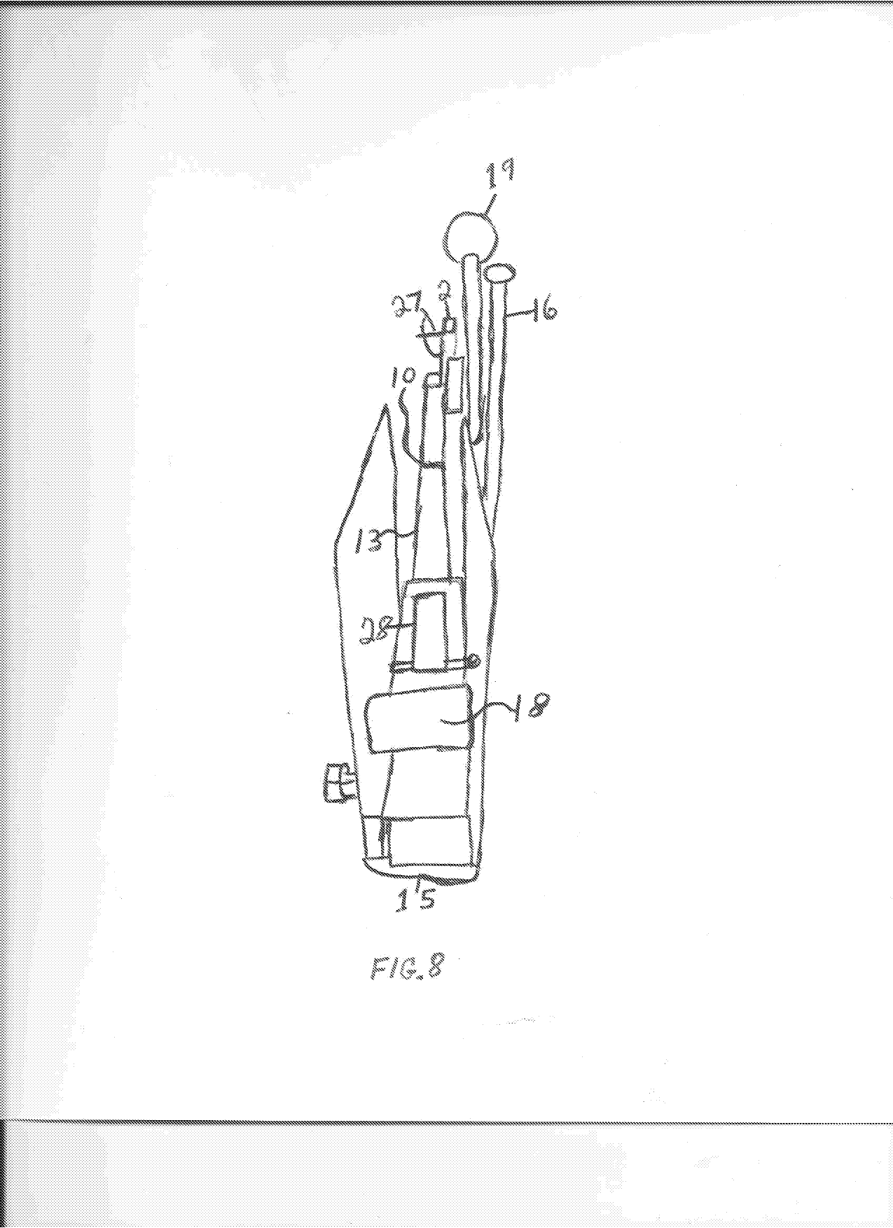

FIG. 8 shows adjustable string trimmer hand grip cradle is from butt end with throttle finger mechanism. Throttle lever is also shown.

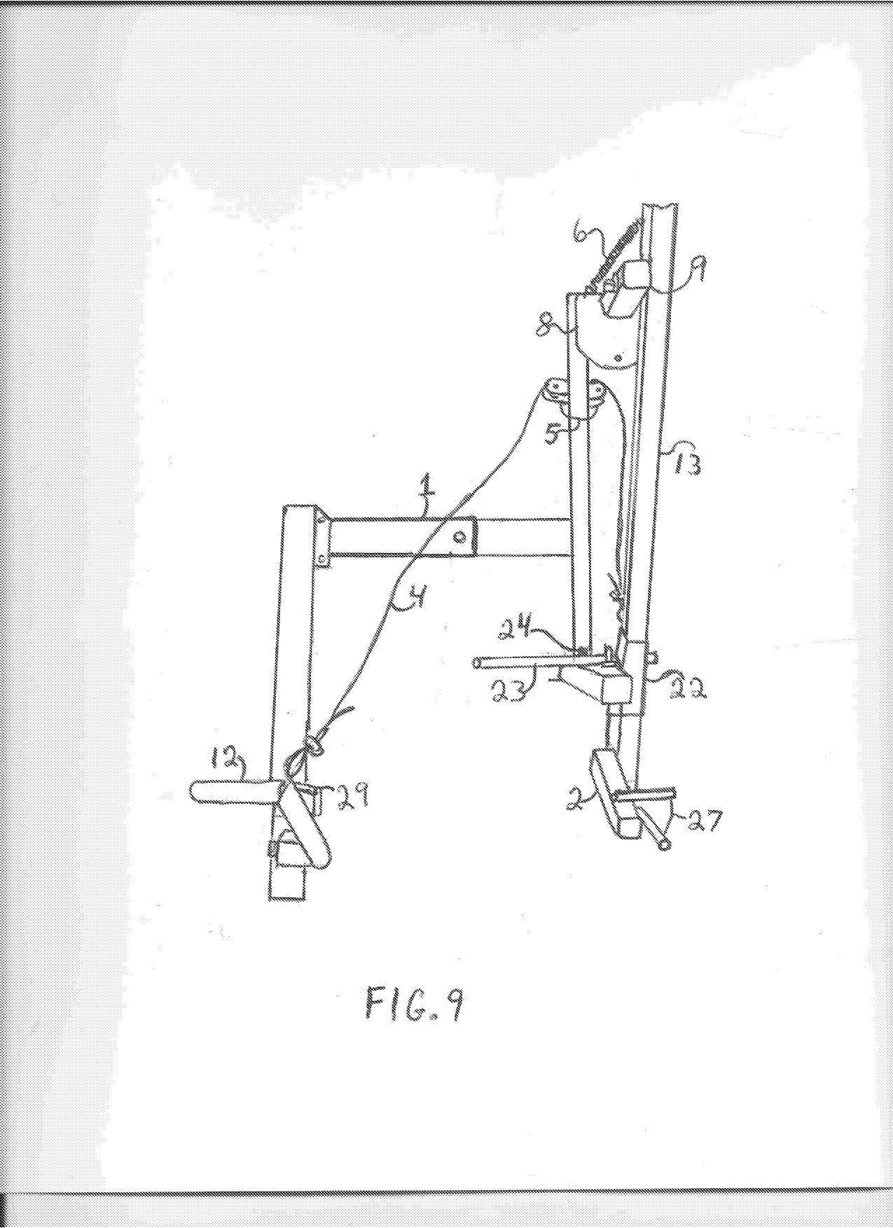

FIG. 9 shows top view of tractor mount L arm where it connects to commercial zero-turn mower's main frame (The hand grip cradle is not shown)

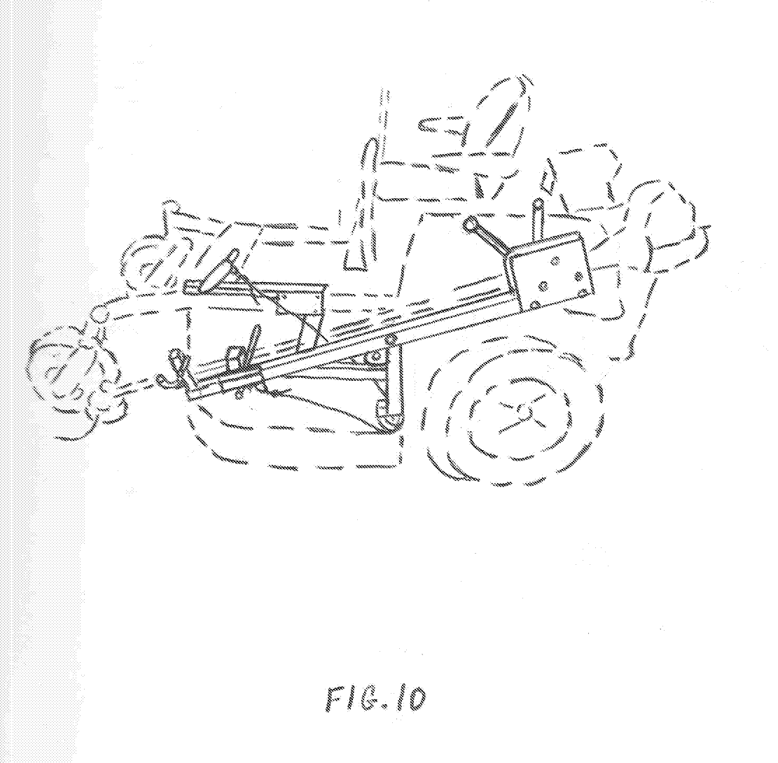

FIG. 10 shows the string trimmer rack in its environment mounted to a commercial zero-turn mower (shown in broken lines) with string trimmer (shown in broken lines) installed in string trimmer rack apparatus.

### DRAWINGS

### Reference Numerals

1 adjustable tractor mount
2 transport mount shaft
3 adjustable inward outward or yaw L arm with cable pulley
4 control cable
5 cable pulleys
6 yaw swivel tension spring
7 adjustable vertical support pole
8 yaw swivel or width of cut adjustable plate
9 pitch axis swivel point with bushings and pin
10 roll axis swivel point
11 roll axis tensioner control handle or mechanical actuator
12 pitch control (flotation of string trimmer's string head) and string feed foot pedal can be manual control or mechanical actuator
13 main support shaft
14 adjustable cable connector
15 adjustable string trimmer hand grip cradle with throttle mechanism
16 throttle control
17 locking pin (for operator presence mechanism)
18 trimmer positioning bolt
19 roll axis control handle (this could be a mechanical actuator)
20 yaw or inward outward lateral axis swivel point
21 pitch or height of cut axis swivel point stop
22 main support shaft transport cradle
23 main support shaft locking and release handle
24 locking handle tension spring
25 roll axis support shaft
26 pitch axis to yaw axis support shaft
27 string trimmer shaft cradle
28 throttle finger mechanism
29 foot pedal mount plate

### DETAILED DESCRIPTION

### One Embodiment is Illustrated

First the main frame mounted tractor mount (1) needs to be assembled by cutting the mount plate to size and attaching tube stock to it. Then cut the L arm (3) tube stock to size and attach together to form the horizontal to vertical transition. The horizontal side of the L arm (3) must be cut from stock that will slide inside the tractor mount (1) and allow it to be adjustable.

Then the cable pulleys (5) will need to be installed. The adjustable support pole (7) will need to be cut from a piece of stock that slides into vertical side of the L arm (3).

The vertical support pole will have a yaw axis swivel point (20) installed just above where the L arm (3) ends.

Atop the vertical support pole (7) the bottom half of the pitch to yaw (26) will then be attached. Then the main support shaft (13) will slide over the swivel pitch axis (9) mounted on top of the pitch to yaw axis shaft (26).

Install the adjustable hand grip cradle mount (15) to the rear of the roll axis (25) support to the rear of the roll axis (25) support shaft, which is made from attaching two plates, then installing the throttle handle (16) with the throttle mechanism (26 FIG. 8) mounted on the inside and then drilling two holes and installing the locking pin (17) behind the roll axis point (10) on the roll axis shaft (25).

Install the roll axis swivel point (10) behind pitch flotation axis point (9). Install the adjustable cable connector (14) made from a small piece of stock that is just large enough to slide over the main support shaft (13) and a cable connector mounted to the underside.

Moving to the front end of the main support shaft (13) install the string trimmer shaft cradle (27). It is cut from a piece of stock and then attaching two pins in place they wrap around the bottom of the string trimmer's shaft and hold the top of the string trimmer's shaft in place approximately 1-12 inches back from the string trimmer's string head.

The cable (4) will then be routed through the cable pulleys (5) on the L arm (3) and attached to the adjustable cable connector (14) on the main support shaft (13). The other end attaches to the foot pedal (29) mounted on the mower. Attach springs (6) and (24) as shown in (FIG. 1). Tighten all hardware as needed. Mount complete system to mowers main frame.

### Operation

The manner for using the string trimmer rack apparatus is as follows: First, the operator would place a string trimmer in the string trimmer rack and start the string trimmer. The operator then would board the zero-turn commercial mower. The operator then takes hold of handle (23) and moves the string trimmer rack apparatus from transport position to trim position. The operator would then take hold of the throttle control (16) and move it to set desired engine RPM of the string trimmers engine. At this point the operator could start normal mowing operation on the commercial zero-turn mower.

To engage string trimmer's string head operator would gently press foot control to lower string trimmer's string head bringing it down in a vertical plane from transport position into trimming position. The operator would be able to float trimmer head along the ground or turf contours. If the string trimmer string head needed rolled left or right the operator would move roll axis handle (19) to desired preference and continue trimming. The operator would use the roll axis tensioner handle (11) to set desired tension of roll axis control handle (19). When finished the operator would reverse these steps and could remove the string trimmer for hand trimming operations.

The operator can also set the overall height of string trimmer from the ground by adjusting the protrusion of adjustable vertical support shaft pole (7) from the vertical side of the adjustable L arm (3) and setting tension bolts.

### Advantages

From the description above a number of advantages of the embodiment of the trimmer rack apparatus become evident:

(a) The trimmer rack apparatus is fairly small, light weight, and cheap to manufacture.

(b) The operator is able to use the trimmer rack apparatus with equipment already owned or needed for such a profession.

(c) The string trimmer rack apparatus is floated with the foot operated control.

(d) The foot operated control offers greater control of the trimmer's string head.

(e) The foot operated control allows feed of the trimmer's line when needed.

### Conclusion, Ramification, and Scope

Accordingly, the reader will see that the string trimmer rack apparatus allows the operator to use multiple different hand held string trimmers in the same string trimmer rack apparatus. The operator can use their existing zero-turn mower and have the freedom to drive it with both hands, while having amazing control of their string trimmer with the foot operated flotation control and then when needed pressing the pedal firmly to press the string trimmer's bump head against a hard surface or the ground to feed more trimmer line.

Furthermore, it permits the operator, with a throttle control to set the desired engine RPM's of the string trimmer's engine.

Additional advantages include:
It permits the operator to adjust the left to right roll axis of the string trimmer's head to match changes in ground contour.
It allows the operator to remove the trimmer very quickly for hand trimming operations.
It provides the operator the ability to place the string trimmer in a transport position over the mower deck and out of the way for mowing only operation.
It provides a foot control which offers amazing control of string trimmer's head flotation and allows feeding line from the string trimmer's head by pressing pedal firmly which in turn forces the trimmer's bump head down against a hard surface or ground to extend more line.

Although my description above contains many specifities these should not be construed as to limit the scope of the embodiments. Other examples could have other shapes such as triangular, oval, circular, trapezoidal, etc.

The axis points could be controlled or driven by other means such as hydraulic, electric, pulley, gears, drive shafts, electronics, sensors, computers or other mechanical drives etc.

Thus the scope of the embodiments should be determined by the claims and their legal equivalents, rather than by the examples given.

I claim:

1. A string trimmer rack system with a foot control for a zero turn commercial lawn mower, comprising:
a mounting means for attaching,
(a.) a string trimmer rack to a zero turn lawnmower, wherein said lawn mower has a deck for mowing grass and also has a main frame, wherein a mount for attaching said string trimmer rack, attaches to said frame and,
(b.) a horizontal to a vertical support pole attaches to said mount upon which,
(c.) a main support shaft mounts on,
(d.) a triaxial pivot point mechanism, wherein a hand held string trimmer having a shaft, a engine, a hand grip, and a string head for cutting grass is mounted to said main support shaft with,
(e.) a hand grip cradle and,
(f.) a trimmer shaft cradle whereby,
(g.) a foot control is used for flotation of said hand held string trimmer, said hand held string trimmer having a bump style, string feed, string head, wherein is a roll of trimmer string, whereby said foot control is used for bumping said string head against a hard surface to feed more said trimmer string when needed,
(h). a inward and outward lateral movement pivot point with,
(i.) a mechanical control allowing said hand held string trimmer to be carried over the top of the said lawn mower deck parallel to said lawnmower, suspended over top of said lawnmower deck out of the way and can be swung outward to the front and side of said mower deck for trimming function,
(j.) a roll pivot point with,
(k.) a mechanical control allowing said hand held string trimmer to be rolled left and right when in a parallel plane to said lawnmower, wherein said horizontal support pole extends from said mount to a predetermined distance to side of said lawnmower, there it transitions to said vertical support pole, whereby said main support pole is attached to top of said vertical support pole by said triaxial pivot point, whereby providing three axises of movement, pitch, roll and yaw to said main support shaft, on front end of main support shaft is mounted said string trimmer shaft cradle for holding said string trimmer shaft, and on opposite end is said hand grip cradle for holding said string trimmer hand grip, said hand grip has,
(l.) a throttle apparatus with,
(m.) a hand control and,
(n.) a internal finger in said hand grip for setting said engine revolution per minute of said string trimmer said engine,

2. The trimmer rack system of claim 1 wherein the support shaft being of sufficient size to accommodate mounting the string trimmer to the zero turn mower,

3. The support shaft of claim 1 wherein on one end of the support shaft are fingers for holding the string trimmer's shaft, and on the opposite end of the shaft is the hand grip cradle for holding the string trimmer hand grip,

4. The hand grip cradle of claim 1 wherein having the throttle apparatus for controlling said string trimmer engine revolutions per minute by applying pressure to the string trimmer throttle control with the finger aperture inside the hand grip apparatus, with the finger being controlled by the hand operated throttle control.

5. A string trimmer rack apparatus of the type, comprising:
(a.) a shaft that supports and provides triaxial control of a hand held string trimmer that has,
(b.) a pivot point for allowing said string trimmer to be rotated or rolled side to side, said shaft is pivotally mounted in,
(c.) a horizontal position to,
(d.) a supporting vertical shaft thereby allowing an operator to control flotation, height of cut, or pitch of said string trimmer, the vertical shaft provides,
(e.) a inward and outward, or yaw axis swivel point for swinging said string trimmer from transport to trim position,

6. The trimmer rack apparatus of claim 5 wherein the supporting vertical shaft is attached to the commercial zero turn lawn mower main frame with the mounting plate.

7. A string trimmer rack apparatus for a zero turn mower of the type, comprising:
(a.) a foot control for a string trimmer having a bump feed string head, and thereby allowing the feeding of more trimmer line by tapping said string head against a hard surface by pressing said foot control firmly, and thereby controlling the height of cut, flotation, or pitch of said string trimmer's string head with said foot control,

8. The foot control of claim 7 wherein said foot control controls flotation of the string trimmer string head independently, or in conjunction of the commercial zero-turn lawn mower to allow following of ground contours.
